(19) United States
(12) Patent Application Publication
(10) Pub. No.: US 2009/0132582 A1
(43) Pub. Date: May 21, 2009

(54) PROCESSOR-SERVER HYBRID SYSTEM FOR PROCESSING DATA

(76) Inventors: Moon J. Kim, Wappingers Falls, NY (US); Rajaram B. Krishnamurthy, Wappingers Falls, NY (US); James R. Moulic, Poughkeepsie, NY (US)

Correspondence Address: HOFFMAN WARNICK LLC, 75 STATE ST, 14TH FLOOR, ALBANY, NY, 12207, US

(21) Appl. No.: 11/940,470

(22) Filed: Nov. 15, 2007

(51) Int. Cl. G06F 17/30

(52) U.S. Cl. 707/104.1; 707/E17.005

(57) ABSTRACT

The present invention relates to a processor-server hybrid system that comprises (among other things) a set (one or more of servers (e.g., mainframes) and a set of front-end application optimized processors. Moreover, implementations of the invention provide a server and processor hybrid system and method for distributing and managing the execution of applications at a fine-grained level via an I/O-connected hybrid system. This method allows one system to be used to manage and control the system functions, and one or more other systems to co-processor.

### CROSS-REFERENCE TO RELATED APPLICATIONS

This application is related in some aspects to commonly owned and co-pending patent application Ser. No. (to be provided), entitled “SERVER-PROCESSOR HYBRID SYSTEM FOR PROCESSING DATA”, assigned attorney docket number END920070375US1, filed Nov. 15, 2007, the entire contents of which are herein incorporated by reference. This application is related in some aspects to commonly owned and co-pending patent application Ser. No. 11/877,926, entitled “HIGH BANDWIDTH IMAGE PROCESSING SYSTEM”, assigned attorney docket number END920070398US1, filed Oct. 24, 2007, the entire contents of which are herein incorporated by reference. This application is related in some aspects to commonly owned and co-pending patent application Ser. No. 11/767,728, entitled “HYBRID IMAGE PROCESSING SYSTEM”, assigned attorney docket number END920070110US2, filed Jun. 25, 2007, the entire contents of which are herein incorporated by reference. This application is also related in some aspects to commonly owned and co-pending patent application Ser. No. 11/738,723, entitled “HETEROGENEOUS IMAGE PROCESSING SYSTEM”, assigned attorney docket number END920070110US1, filed Apr. 23, 2007, the entire contents of which are herein incorporated by reference. This application is also related in some aspects to commonly owned and co-pending patent application Ser. No. 11/738,711, entitled “HETEROGENEOUS IMAGE PROCESSING SYSTEM”, assigned attorney docket number END920070111US1, filed Apr. 23, 2007, the entire contents of which are herein incorporated by reference.

### FIELD OF THE INVENTION

The present invention generally relates to data processing. Specifically, the present invention relates to a processor-server hybrid system for more efficient data processing.

### BACKGROUND OF THE INVENTION

Web 1.0 is historically referred to as the World Wide Web, which was originally about connecting computers and making technology more efficient for computers. Web 2.0/3.0 is considered to encompass the communities and social networks that build contextual relationships and facilitates and knowledge sharing and virtual web servicing. Traditional web service can be thought of as a very thin client. That is, a browser displays images relayed by a server, and every significant user action is communicated to the server for processing. Web 2.0 is a social interaction that is consisted of the software layer on the client, so the user gets quick system response. The front-end storage and retrieval of data is conducted asynchronously in the background, so the user doesn't have to wait for the network. Web 3.0 is geared towards the 3 dimensional vision such as in virtual universes. This could open up new ways to connect and collaborate using 3D shared. Along these lines, web 3.0 describes the evolution of Web usage and interaction along several separate paths. These include transforming the Web into a database, a move towards making content accessible by multiple non-browser applications.

Unfortunately, the traditional server cannot efficiently handle the characteristics of Web 3.0. No existing approach addresses this issue. In view of the foregoing, there exists a need for an approach that solves this deficiency.

### SUMMARY OF THE INVENTION

The present invention relates to a processor-server hybrid system that comprises (among other things) a set (one or more) of back-end servers (e.g., mainframes) and a set of front-end application optimized processors. Moreover, implementations of the invention provide a server and processor hybrid system and method for distributing and managing the execution of applications at a fine-grained level via an I/O-connected hybrid system. This method allows one system to be used to manage and control the system functions, and one or more other systems to serve as a front-end co-processor or accelerator for server functions. The application optimized processor is adept at processing real-time streams, bit and byte computation at high throughput and converting streams to transactions that can be easily handled by the server. The server is proficient at resource management, workload management and transaction processing.

The present invention allows the server management and control system components to be reused, and the applications such as virtual web or game processing components to be run on the front-end co-processor. The system components can be run using different operating systems. The server(s) acts as a normal transaction based computing resource, but for which these transactions are constructed by the front-end processor from real-time streaming data or other multi-modal data passing through it. The processor is placed at the front-end to handle such functions. In addition to traditional transaction processing, the server(s) would also perform specific processor selection functions, and set-up, control and management functions of the application-optimized processors e.g. cell co-processors.

A first aspect of the present invention provides a processor-server hybrid system for processing data, comprising: a set of front-end application optimized processors for receiving and processing the data from an external source; a set of back-end servers for processing the data, and for returning processed data to the set of front-end application optimized processors; an interface having a set of network interconnects, the interface connecting the set of back-end servers with the set of front-end application optimized processors.

A second aspect of the present invention provides a method for processing data, comprising: receiving the data from an external source on a front-end application optimized processor; sending the data from the front-end application optimized processor to a back-end server via an interface having a set of network interconnects; processing the data on the back-end server to yield processed data; and receiving the processed data from the back-end server on the front-end application optimized processor.

A third aspect of the present invention provides a method for deploying a processor-server hybrid system for processing data, comprising: providing a computer infrastructure being operable to: receive the data from an external source on a front-end application optimized processor; send the data from the front-end application optimized processor to a back-end server via an interface having a set of network interconnects; process the data on the back-end server to yield processed data; and receive the processed data from the back-end server on the front-end application optimized.

### BRIEF DESCRIPTION OF THE DRAWINGS

These and other features of this invention will be more readily understood from the following detailed description of the various aspects of the invention taken in conjunction with the accompanying drawings in which:

FIG. 1 shows box diagram depicting the components of the processor-server hybrid system according to the present invention.

FIG. 2A shows a more detailed diagram of the system of FIG. 1 according to the present invention.

FIG. 2B shows a more specific diagram of the front-end application optimized processors(s) of the hybrid system according to the present invention.

FIG. 3 shows communication flow within the processor-server hybrid system according to the present invention.

FIGS. 4A-D shows a method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The present invention relates to a processor-server hybrid system that comprises (among other things) a set (one or more) of back-end servers (e.g., mainframes) and a set of front-end application optimized processors. Moreover, implementations of the invention provide a server and processor hybrid system and method for distributing and managing the execution of applications at a fine-grained level via an I/O-connected hybrid system. This method allows one system to be used to manage and control the system functions, and one or more other systems to serve as a co-processor or accelerator for server functions.

The present invention allows the server management and control system components to be reused, and the applications such as virtual web or game processing components to be used as an accelerator or co-processor. The system components can be run using different operating systems. The server(s) acts as a normal transaction based computing resource, but for which these transactions are constructed by the front-end processor from real-time streaming data or other multi-modal data passing through it. The processor is placed at the front-end to handle such functions. In addition to traditional transaction processing, the server(s) would also perform specific processor selection functions, and set-up, control and management functions of the cell co-processors. Having the processor on the front-end provides (among other things) real-time predictable processing for streams and multi-modal data as deep cache hierarchies of server can lead to processing time variability, high throughput bit, byte and vector data processing, convert streams and multi-modal data into transactions for input to the back-end server.

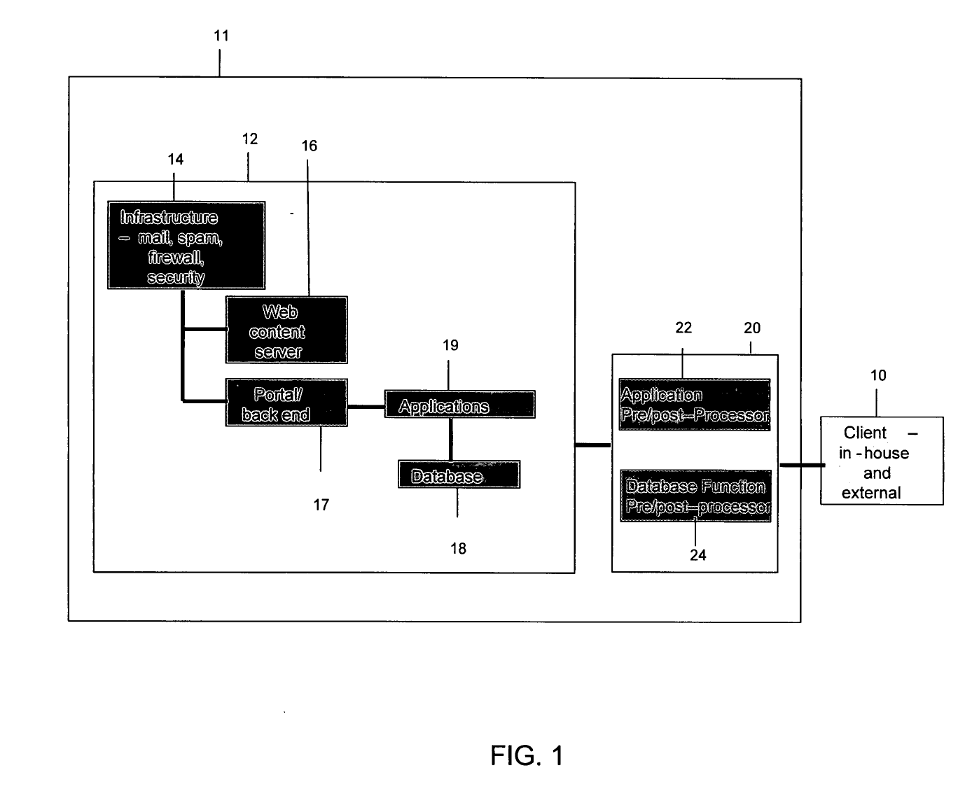

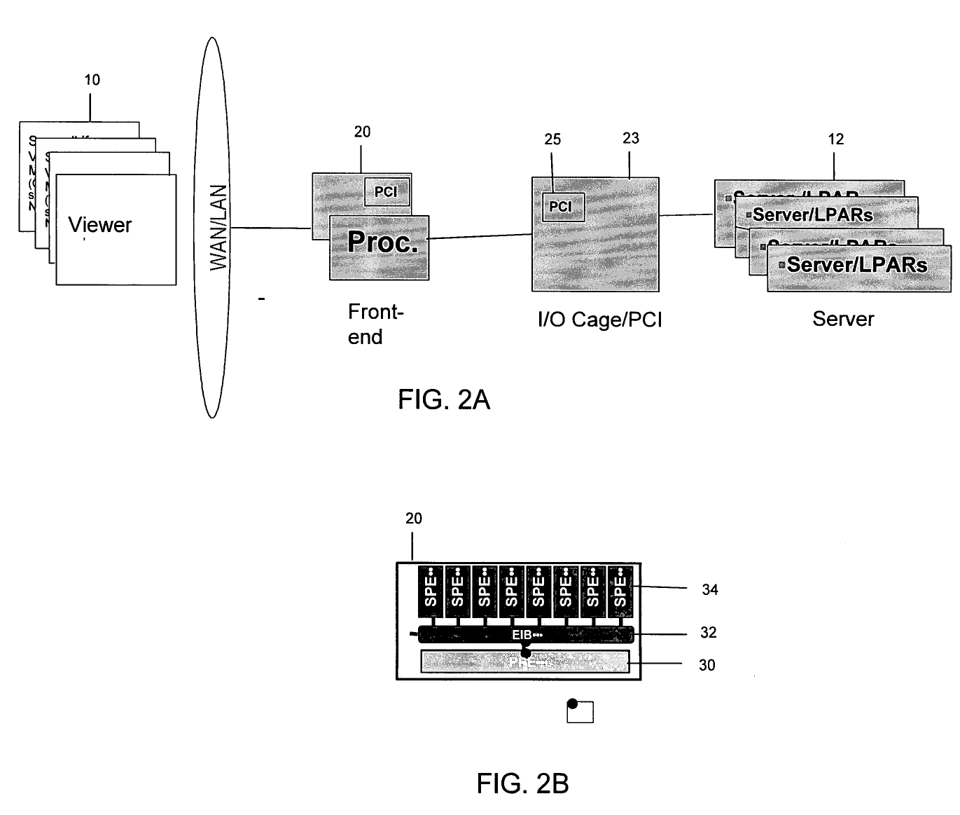

Referring now to FIG. 1 a logical diagram according to the present invention is shown. In general, the present invention provides a processor-server hybrid system 11 that comprises a set (one or more) back-end servers 12 (hereinafter server 12) and a set of front-end application optimized processors 20 (hereinafter processors 20). As shown, each server 12 typically includes infrastructure 14 (e.g., email, spam, firewall, security, etc.), a web content server 16, and portal/front end 18 (e.g., an interface as will be further described below). Applications 19 and databases 18 are also hosted on these servers. Along these lines server(s) 12 are typically System z servers that are commercially available from IBM Corp. of Armonk, N.Y. (System z and related terms are trademarks of IBM Corp. in the United States and/or other countries). Each processor 20 typically includes one or more application pre-processors 22, and one or more database function pre-processors 24. Along those lines, processor(s) 20 are typically cell blades that are commercially available from IBM Corp. (cell, cell blade and related terms are trademarks of IBM Corp in the United States and/or other countries). As shown, processor 20 receives data from an external source 10 via typically communication methods (e.g., LAN, WLAN, etc.). Such data is communicated to server 12 for processing via an interface of server 12 (shown in FIG. 2A). Processed data can then be stored and/or returned to processor 20 for further processing and onto external source 10. As depicted, processor 20 represents the front-end of hybrid system 11 while server 12 represents the back-end. It is to be noted that processor 20 may directly pass data from external client 10 directly to server 12 without any pre-processing. Similarly, processed data from server 12 may be directly sent to external client 12 without processor 20 intervening.

This system is further shown in FIGS. 2A-B. FIG. 2A shows external source(s) 10 communicating server(s) 12, which communicates with processor(s) 20 via interface 23. Typically, interface 23 is an input/output (I/O) cage embodied/contained within each server 12. Interface 23 also includes a set of network interconnects such as express peripheral component interconnects (PCIes) 25. Interface 23 may also include other components as indicated in the above-incorporated patent applications.

In any event, data will be received from external source(s) 10 on processor(s) 20 and communicated to server(s) 12 via interface(s) 23. Once received, server(s) 12 can process the data, return the processed data to processor(s) 20, which can further process the same and/or return the processed data to external source(s) 10. Processor(s) 20 can also leverage staging storage and processed data storage devices to store the original data and/or the processed data. As shown in FIG. 2B, each processor 20 typically includes a power processing element (PPE) 30, an element interconnect bus (EIB) 32 coupled to the PPE, and a set (e.g., one or more) but typically a plurality of special purpose engines (SPEs) 34. The SPEs share the load for processing the data.

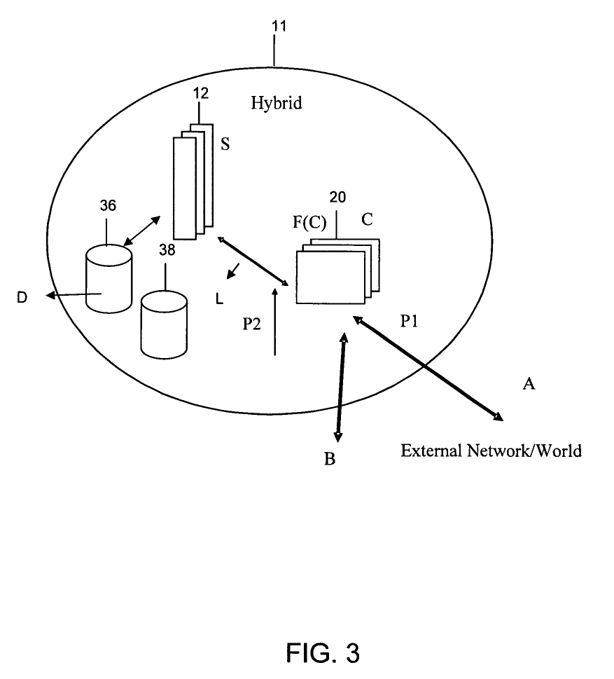

Referring briefly to FIG. 3, a more specific diagram showing the components' placement within hybrid system 11 is shown. As depicted, processor(s) 20 receive/send data from external sources A and B, and route that data to server(s) 12 for processing. After such processing, processed data is returned to processor(s) 20, and to external sources A and B. Also present in hybrid system 11 is staging storage device 36 and processed data storage device 38. Staging storage device 36 can be used to store data prior to, during and/or after being processed, while processed data storage device can be used to store processed data.

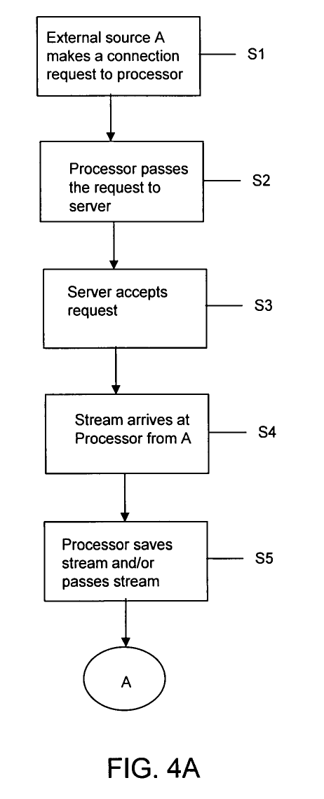

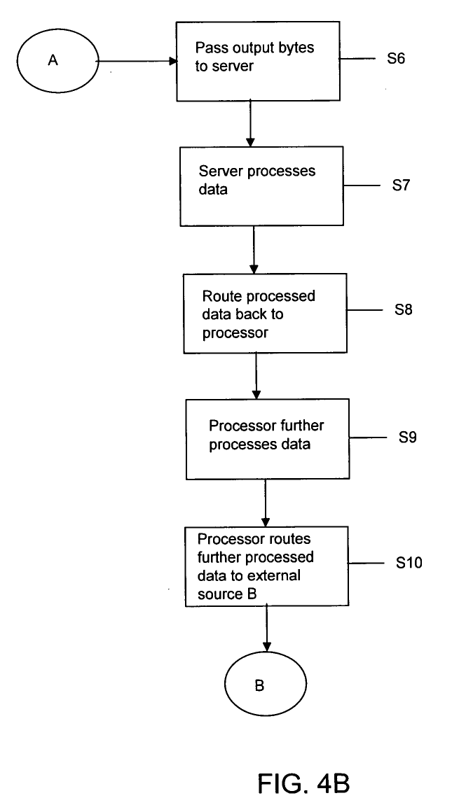

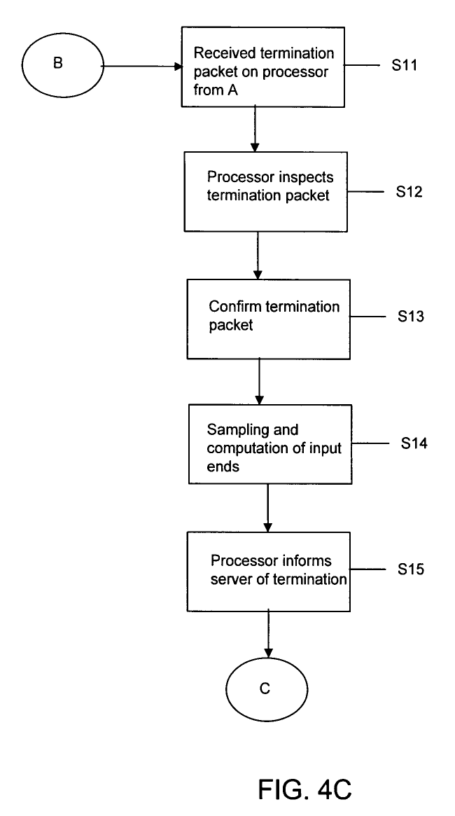

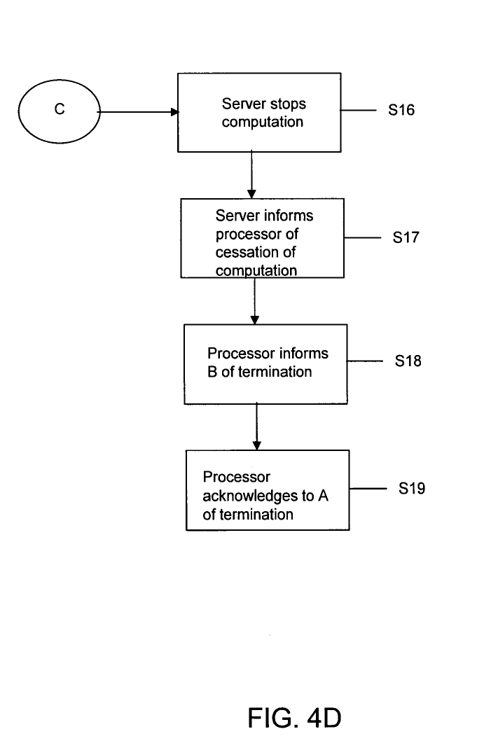

Referring now to FIGS. 4A-D, a flow diagram of an illustrative process according to the present invention will be described. For brevity purposes (for the remainder of the Detailed Description of the Invention, server 12 of is referred to as “S”, while processor 20 is referred to as “C”. In step S1 external source (A) makes a connection request to C. In step S2, the connection request is passed on to S after validation by server C. In step S3, S accepts connection, C informs A of connection setup completeness. In step S4 stream P arrives from A at server C. C performs P′=F(P) where F is a transformation function on stream P. In step S5, C can save the data in storage and/or pass it to another device. In step S6, Output bytes are continuously passed onto S. In step S7, S performs P″=U(P′) where U is transformation function performed by S. In step S8, P″ is routed to back to C. C performs P³=V(P″) where V is a transformation function performed by processor C in step S9. In step S10, P³ is routed continuously to B or A. Additionally, in step S10, A presents connection termination packet (E). In step S11, C receives E and in S12 C inspects E. In step S13, it is determined that E is a connection termination packet. In step S14, input sampling and computation stops. In step S15, C informs S of stream completion. In step S16, S stops computation. In step S17, S informs C of computation termination. In step S18, C informs B of connection termination. In step S19, C acknowledges A of computation completion.

Although not separately shown in a diagram the following is an example of another control flow made possible under the present invention. This control flow is useful in scenarios where requests are made directly by C to S without data being sourced from A or redirected to B. This is useful for reference and historical data lookups.
1. C makes connection request
2. Is the connection request valid? (performed by S)
3. If yes, accepted by S
4. Stream P arrives from C at Server S (P can also just be “block” input with a predefined length or other multi-modal data)
5. S performs F(P) where F is a transformation function on stream P
6. F(P) Output bytes are continuously passed back to C
7. C encounters End-of-File or End of Stream
8. C presents connection termination packet (E)
9. S inspects E
10. Is E a connection termination packet?
11. If Yes, stop sampling inputs, stop computation on S
12. S acknowledges C on computation termination

Although not separately shown in a diagram the following is an example of yet another control flow made possible under the present invention. This control flow is useful in scenarios where requests are made directly by S to C without data being sourced from A or redirected to B. In this case, server S has a list of external clients that it can contact. This is useful for scenarios where the server S must “push” data to an external client that has subscribed to the services of server S (e.g. IP multicast) but needs C to “post-process” data that is suitable for consumption by external clients.
13. S makes connection request
14. Is the connection request valid? (performed by C)
15. If yes, accepted by C
16. Stream P arrives from S at Processor C (P can also just be “block” input with a predefined length or other multi-modal data)
17. C performs F(P) where F is a transformation function on stream P
18. F(P) Output bytes are continuously “pushed” out from C to external clients
19. S encounters End-of-File or End of Stream
20. S presents connection termination packet (E)
21. C inspects E
22. Is E a connection termination packet?
23. If Yes, stop sampling inputs, stop computation on C
24. C acknowledges S on computation termination

Under the present invention, both a push model and a pull model can be used. Control messages can be sent across a separate control path with data messages being sent over the regular data path. Here two separate connection IDs are needed. Control messages can also be sent along with data messages across the same path. In this case, only one connection ID is needed. Both Push and Pull models can be realized for separate or unified data path and control path. The push model is useful for short data where latency is a concern. Control messages usually have latency bounds for data transfer. This requires engagement of the data source computer processor until all the data is pushed out. The pull model is usually useful for bulk data where the destination computer can read data directly from the source's memory without involving the source's central processor. Here the latency of communicating the location and size of the data from the source to the destination can easily be amortized over the whole data transfer. In a preferred embodiment of this invention, push and pull model can be invoked selectively depending on the length of data to be exchanged.

The following steps show how the push and pull models works:

### Dynamic Model Selection

(1) C and S want to communicate. Sender (C or S) makes the following decisions—
Step 1—Is data of predefined length, less than Push Threshold (PT) and possibly has a real-time deadline on receipt at the destination?
Step 2—If yes, then employ “push”
Step 3—if no, then data is of streaming nature without any known size. Sender “shoulder taps” receiver with location address of data.
   Push Threshold (PT) is a parameter that can be chosen for a given application or data type (fixed length or stream) by the designer of the system.

### Push Model

C shoulder taps S with data block size (if known).

C looks up application communication rate requirements (R).

C looks up # of links in “link aggregation pool” (N).

C matches R and N by expanding or shrinking N [dynamic allocation by link coalescing].

C and S agree on number of links required for data transfer C pushes data to S.

C can close connection in the following ways—when all data is sent (size known) & when job is complete.

C closes connection by shoulder tap to S.

### Pull Model

C shoulder taps S with data block size (if known) and address location of first byte.
C looks up application communication rate requirements (R).
C looks up # of links in “link aggregation pool” (N).
C matches R and N by expanding or shrinking N [dynamic allocation].
C and S agree on number of links required for data transfer
S pulls data from C memory.
C can close connection in the following ways—when all data is sent (size known) & when job is complete.
C closes connection by shoulder tap to S

In FIG. 3, C and S share access to staging storage device 36. If C needs to transfer dataset D to S then the following steps must happen—(i) C must read D and (ii) transfer D to S over link L. Instead, C can inform S of the name of the dataset and S can read this dataset directly from 36. This possible because C and S share staging device 36. The steps required for this are listed as follows—

Step 1—C provides dataset name & location (dataset descriptor) along control path to S. This serves as “shoulder tap”. S receives this information by polling for data, “pushed” from C.

Step 2—S reads data from D using dataset descriptor.

Step 1—Push or pull implementation possible.

Step 2—Pull or push implementation possible.

Step 1 (push)—“Control Path”
C shoulder taps (writes to) S with dataset name & location (if known).

Step 1 (pull)—“Control Path”
C shoulder taps S with data block size (if known).
S pulls data from C memory.

Step 2 (Pull form)—“Data path”
36 stores table with dataset name and dataset block locations.
S makes read request to 36 with dataset name D.
36 provides a list of blocks to S with “pointer”/address to first block.
S reads blocks from 36
S encounters end of dataset.
S closes connection.

Step 2 (push form)—“Data Path”
36 stores table with dataset name and dataset block locations.
S makes read request to 36 with dataset name D and location/address of receiving buffer on S.
Storage controller of 36 pushes disk blocks of D directly into memory of S.
36 closes connection.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A processor-server hybrid system for processing data, comprising:
a set of front-end application optimized processors for receiving and processing the data from an external source;
a set of back-end servers for processing the data, and for returning processed data to the set of front-end application optimized processors;
an interface having a set of network interconnects, the interface connecting the set of back-end servers with the set of front-end application optimized processors.

2. The processor-server hybrid system of claim 1, the interface being an input/output (I/O) cage.

3. The processor-server hybrid system of claim 1, each of the set of front-end application optimized processors comprising:
a power processing element (PPE);
an element interconnect bus (EIB) coupled to the PPE; and
a set of special purpose engines (SPEs) coupled to the EIB.

4. The processor-server hybrid system of claim 3, the set of SPEs being configured to process the data.

5. The processor-server hybrid system of claim 1, further comprising a web content server, portal, an application, a database, an application pre-/post-processor and a database function.pre-/post-processor.

6. The processor-server hybrid system of claim 1, further comprising:
a staging storage device; and
a processed data storage device.

7. A method for processing data, comprising:
receiving the data from an external source on a front-end application optimized processor;
sending the data from the front-end application optimized processor to a back-end server via an interface having a set of network interconnects;
processing the data on the back-end server to yield processed data; and
receiving the processed data from the back-end server on the front-end application optimized processor.

8. The method of claim 7, the interface being an input/output (I/O) cage.

9. The method of claim 7, the front-end application optimized processor comprising:
a power processing element (PPE);
an element interconnect bus (EIB) coupled to the PPE; and
a set of special purpose engines (SPEs) coupled to the EIB.

10. The method of claim 7, the set of SPEs being configured to process the data.

11. The method of claim 7, further comprising a web content server, portal, an application, a database, an application pre-/post-processor and a database pre-/post-processor.

12. A method for deploying a processor-server hybrid system for processing data, comprising:
providing a computer infrastructure being operable to:
receive the data from an external source on a front-end application optimized processor;
send the data from the front-end application optimized processor to a back-end server via an interface having a set of network interconnects;
process the data on the back-end server to yield processed data; and
receive the processed data from the back-end server on the front-end application optimized processor.

13. The method of claim 12, the interface being an input/output (I/O) cage.

14. The method of claim 12, the interface being embodied in at least one of the set of servers.

15. The method of claim 12, the front-end application optimized processor comprising:
a power processing element (PPE);
an element interconnect bus (EIB) coupled to the PPE; and
a set of special purpose engines (SPEs) coupled to the EIB.

16. The method of claim 15, the set of SPEs being configured to process the data.

17. The method of claim 13, further comprising:
a staging storage device; and
a processed data storage device.

18. The method of claim 13, further comprising a web content server, portal, an application, a database, an application pre-/post-processor and a database function pre-/post-processor.
